(19) United States
(12) Patent Application Publication
(10) Pub. No.: US 2026/0278110 A1
(43) Pub. Date: Sep. 17, 2026

(54) High Availability Evaluation of Real-World Systems using Digital Twins

(71) Applicant: International Business Machines Corporation, Armonk, NY (US)

(72) Inventors: Peng Hui Jiang, Beijing (CN); Jia Tian Zhong, Hong Kong (HK); Jun Su, Beijing (CN); Dong Hui Liu, Beijing (CN); Jing Lu, Beijing (CN); Jia Yu, Beijing (CN)

(21) Appl. No.: 19/078,644

(22) Filed: Mar. 13, 2025

(51) Int. Cl. G06F 21/57

(52) U.S. Cl. CPC G06F 21/577; G06F 2221/034

(57) ABSTRACT

Evaluating system high availability is provided. An analysis of a result of a system availability and resiliency assessment of a real-world system is performed under each of a plurality of simulation scenarios based on a set of metrics. A set of recommendations is generated to increase system availability and resiliency of the real-world system based on the analysis of the result of the system availability and resiliency assessment of the real-world system under each of the plurality of simulation scenarios utilizing the set of metrics.

### BACKGROUND

The disclosure relates generally to system high availability and more specifically to evaluating high availability of systems.

High availability is a term that refers to an ability of a system to be accessible and reliable close to 100% of the time. Highly available systems must be able to withstand outages, including scheduled downtime and site-wide disasters. Typically, high availability systems meet two characteristics: 1) high availability systems should be available for use close to 100% of the time; and 2) high availability systems should be able to meet certain user expectations.

High availability systems are particularly important in industries where critical applications rely on having little or no system downtime. For example, in healthcare systems such as hospitals, financial systems such as stock exchanges, banking systems, data centers, governmental agencies, and the like, users depend on system high availability to perform many routine and daily functions. In other words, these types of systems are important to the users’ lives. If users cannot access one of these systems for any reason, the system is considered “unavailable.” The period of time that the system is unavailable to users is known as downtime.

### SUMMARY

According to one illustrative embodiment, a method is provided. A computer performs an analysis of a result of a system availability and resiliency assessment of a real-world system under each of a plurality of simulation scenarios based on a set of metrics. The computer generates a set of recommendations to increase system availability and resiliency of the real-world system based on the analysis of the result of the system availability and resiliency assessment of the real-world system under each of the plurality of simulation scenarios utilizing the set of metrics. According to other illustrative embodiments, a computer system and computer program product are provided.

### BRIEF DESCRIPTION OF THE DRAWINGS

FIG. 1 is a pictorial representation of a computing environment in which illustrative embodiments may be implemented;

FIG. 2 is a diagram illustrating an example of a high availability evaluation system in accordance with an illustrative embodiment; and

FIGS. 3A-3B are a flowchart illustrating a process for evaluating high availability of real-world systems using digital twins in accordance with an illustrative embodiment.

### DETAILED DESCRIPTION

A computer performs an analysis of a result of a system availability and resiliency assessment of a real-world system under each of a plurality of simulation scenarios based on a set of metrics. The computer generates a set of recommendations to increase system availability and resiliency of the real-world system based on the analysis of the result of the system availability and resiliency assessment of the real-world system under each of the plurality of simulation scenarios utilizing the set of metrics. As a result, illustrative embodiments provide a technical effect of providing recommendations to increase system availability and resiliency of real-world systems based on analyzing results of system availability and resiliency assessments of the real-world systems under each of a plurality of simulation scenarios that allow for safe simulations without impacting the real-world systems and, therefore, reducing the risk to these real-world systems.

The computer implements the set of recommendations in a digital twin of the real-world system. The computer determines whether the system availability and resiliency of the real-world system was increased in the digital twin based on implementing the set of recommendations in the digital twin. In response to the computer determining that the system availability and resiliency of the real-world system was increased in the digital twin based on implementing the set of recommendations in the digital twin, the computer implements the set of recommendations in the real-world system automatically to increase the system availability and resiliency of the real-world system. As a result, illustrative embodiments provide a technical effect of automatically implementing recommendations in real-world systems to increase system availability and resiliency of these real-world systems in response to determining that the system availability and resiliency of these real-world systems was increased in digital twins based on implementing the recommendations in the digital twins.

In response to the computer determining that the system availability and resiliency of the real-world system was not increased in the digital twin based on implementing the set of recommendations in the digital twin, the computer sends the set of recommendations to a client device of a user for modification. The computer receives the set of recommendations with the modification from the client device of the user for implementation in the digital twin. As a result, illustrative embodiments provide a technical effect of sending recommendations to a client device of a user for modification in response to determining that the system availability and resiliency of these real-world systems was not increased in digital twins based on implementing the recommendations in the digital twins and receiving the recommendations with the modification from the client device of the user for implementation in the digital twins.

The computer receives a request to perform a high availability evaluation on the real-world system from a client device of a user. The computer collects real-time data corresponding to the real-world system in response to receiving the request to perform the high availability evaluation on the real-world system. The real-time data include system logs, performance metrics, network status, and fault records. As a result, illustrative embodiments provide a technical effect of collecting real-time data corresponding to real-world systems in response to receiving requests to perform high availability evaluations on these real-world systems.

The computer generates a digital twin of the real-world system based on the real-time data corresponding to the real-world system. The digital twin is an accurate virtual representation of the real-world system. The computer generates the plurality of simulation scenarios for the real-world system based on the digital twin of the real-world system. The plurality of simulation scenarios includes different hardware failures, different network outages, and different greater than normal workload levels. As a result, illustrative embodiments provide a technical effect of generating digital twins of real-world systems based on real-time data corresponding to these real-world systems and generating a plurality of simulation scenarios for these real-world systems based on the digital twins. By using real-time data corresponding to these real-world systems, illustrative embodiments can generate accurate and relevant digital twins for evaluation of realistic, data-driven simulations.

The computer performs the system availability and resiliency assessment of the real-world system under each respective simulation scenario of the plurality of simulation scenarios based on the set of metrics. The set of metrics includes at least one of mean time to repair metrics, mean time between failure metrics, and service level agreement metrics. The computer generates the result of the system availability and resiliency assessment of the real-world system under each of the plurality of simulation scenarios based on the set of metrics. As a result, illustrative embodiments provide a technical effect of generating results of system availability and resiliency assessments of real-world systems under each of a plurality of simulation scenarios based on metrics.

The set of recommendations to increase the system availability and resiliency of the real-world system includes adjusting resource allocations of the real-world system and adding resource redundancies to the real-world system. As a result, illustrative embodiments provide a technical effect of adjusting resource allocations of real-world systems and adding resource redundancies to these real-world systems to increase system availability and resiliency of these real-world systems.

A computer system comprises a processor set, one or more computer-readable storage media, and program instructions stored on the one or more computer-readable storage media to cause the processor set to perform operations. The computer system performs an analysis of a result of a system availability and resiliency assessment of a real-world system under each of a plurality of simulation scenarios based on a set of metrics. The computer system generates a set of recommendations to increase system availability and resiliency of the real-world system based on the analysis of the result of the system availability and resiliency assessment of the real-world system under each of the plurality of simulation scenarios utilizing the set of metrics. As a result, illustrative embodiments provide a technical effect of providing recommendations to increase system availability and resiliency of real-world systems based on analyzing results of system availability and resiliency assessments of the real-world systems under each of a plurality of simulation scenarios that allow for safe simulations without impacting the real-world systems and, therefore, reducing the risk to these real-world systems.

The computer system implements the set of recommendations in a digital twin of the real-world system. The computer system determines whether the system availability and resiliency of the real-world system was increased in the digital twin based on implementing the set of recommendations in the digital twin. In response to the computer system determining that the system availability and resiliency of the real-world system was increased in the digital twin based on implementing the set of recommendations in the digital twin, the computer system implements the set of recommendations in the real-world system automatically to increase the system availability and resiliency of the real-world system. As a result, illustrative embodiments provide a technical effect of automatically implementing recommendations in real-world systems to increase system availability and resiliency of these real-world systems in response to determining that the system availability and resiliency of these real-world systems was increased in digital twins based on implementing the recommendations in the digital twins.

In response to the computer system determining that the system availability and resiliency of the real-world system was not increased in the digital twin based on implementing the set of recommendations in the digital twin, the computer system sends the set of recommendations to a client device of a user for modification. The computer system receives the set of recommendations with the modification from the client device of the user for implementation in the digital twin. As a result, illustrative embodiments provide a technical effect of sending recommendations to a client device of a user for modification in response to determining that the system availability and resiliency of these real-world systems was not increased in digital twins based on implementing the recommendations in the digital twins and receiving the recommendations with the modification from the client device of the user for implementation in the digital twins.

The computer system receives a request to perform a high availability evaluation on the real-world system from a client device of a user. The computer system collects real-time data corresponding to the real-world system in response to receiving the request to perform the high availability evaluation on the real-world system. The real-time data include system logs, performance metrics, network status, and fault records. As a result, illustrative embodiments provide a technical effect of collecting real-time data corresponding to real-world systems in response to receiving requests to perform high availability evaluations on these real-world systems.

The computer system generates a digital twin of the real-world system based on the real-time data corresponding to the real-world system. The digital twin is an accurate virtual representation of the real-world system. The computer system generates the plurality of simulation scenarios for the real-world system based on the digital twin of the real-world system. The plurality of simulation scenarios includes different hardware failures, different network outages, and different greater than normal workload levels. As a result, illustrative embodiments provide a technical effect of generating digital twins of real-world systems based on real-time data corresponding to these real-world systems and generating a plurality of simulation scenarios for these real-world systems based on the digital twins. By using real-time data corresponding to these real-world systems, illustrative embodiments can generate accurate and relevant digital twins for evaluation of realistic, data-driven simulations.

The computer system performs the system availability and resiliency assessment of the real-world system under each respective simulation scenario of the plurality of simulation scenarios based on the set of metrics. The set of metrics includes at least one of mean time to repair metrics, mean time between failure metrics, and service level agreement metrics. The computer system generates the result of the system availability and resiliency assessment of the real-world system under each of the plurality of simulation scenarios based on the set of metrics. As a result, illustrative embodiments provide a technical effect of generating results of system availability and resiliency assessments of real-world systems under each of a plurality of simulation scenarios based on metrics.

A computer program product comprises one or more computer-readable storage media and program instructions stored on the one or more computer-readable storage media to perform operations. A computer performs an analysis of a result of a system availability and resiliency assessment of a real-world system under each of a plurality of simulation scenarios based on a set of metrics. The computer generates a set of recommendations to increase system availability and resiliency of the real-world system based on the analysis of the result of the system availability and resiliency assessment of the real-world system under each of the plurality of simulation scenarios utilizing the set of metrics. As a result, illustrative embodiments provide a technical effect of providing recommendations to increase system availability and resiliency of real-world systems based on analyzing results of system availability and resiliency assessments of the real-world systems under each of a plurality of simulation scenarios that allow for safe simulations without impacting the real-world systems and, therefore, reducing the risk to these real-world systems.

The computer implements the set of recommendations in a digital twin of the real-world system. The computer determines whether the system availability and resiliency of the real-world system was increased in the digital twin based on implementing the set of recommendations in the digital twin. In response to the computer determining that the system availability and resiliency of the real-world system was increased in the digital twin based on implementing the set of recommendations in the digital twin, the computer implements the set of recommendations in the real-world system automatically to increase the system availability and resiliency of the real-world system. As a result, illustrative embodiments provide a technical effect of automatically implementing recommendations in real-world systems to increase system availability and resiliency of these real-world systems in response to determining that the system availability and resiliency of these real-world systems was increased in digital twins based on implementing the recommendations in the digital twins.

In response to the computer determining that the system availability and resiliency of the real-world system was not increased in the digital twin based on implementing the set of recommendations in the digital twin, the computer sends the set of recommendations to a client device of a user for modification. The computer receives the set of recommendations with the modification from the client device of the user for implementation in the digital twin. As a result, illustrative embodiments provide a technical effect of sending recommendations to a client device of a user for modification in response to determining that the system availability and resiliency of these real-world systems was not increased in digital twins based on implementing the recommendations in the digital twins and receiving the recommendations with the modification from the client device of the user for implementation in the digital twins.

The computer receives a request to perform a high availability evaluation on the real-world system from a client device of a user. The computer collects real-time data corresponding to the real-world system in response to receiving the request to perform the high availability evaluation on the real-world system. The real-time data include system logs, performance metrics, network status, and fault records. As a result, illustrative embodiments provide a technical effect of collecting real-time data corresponding to real-world systems in response to receiving requests to perform high availability evaluations on these real-world systems.

The computer generates a digital twin of the real-world system based on the real-time data corresponding to the real-world system. The digital twin is an accurate virtual representation of the real-world system. The computer generates the plurality of simulation scenarios for the real-world system based on the digital twin of the real-world system. The plurality of simulation scenarios includes different hardware failures, different network outages, and different greater than normal workload levels. As a result, illustrative embodiments provide a technical effect of generating digital twins of real-world systems based on real-time data corresponding to these real-world systems and generating a plurality of simulation scenarios for these real-world systems based on the digital twins. By using real-time data corresponding to these real-world systems, illustrative embodiments can generate accurate and relevant digital twins for evaluation of realistic, data-driven simulations.

The computer performs the system availability and resiliency assessment of the real-world system under each respective simulation scenario of the plurality of simulation scenarios based on the set of metrics. The set of metrics includes at least one of mean time to repair metrics, mean time between failure metrics, and service level agreement metrics. The computer generates the result of the system availability and resiliency assessment of the real-world system under each of the plurality of simulation scenarios based on the set of metrics. As a result, illustrative embodiments provide a technical effect of generating results of system availability and resiliency assessments of real-world systems under each of a plurality of simulation scenarios based on metrics.

The set of recommendations to increase the system availability and resiliency of the real-world system includes adjusting resource allocations of the real-world system and adding resource redundancies to the real-world system. As a result, illustrative embodiments provide a technical effect of adjusting resource allocations of real-world systems and adding resource redundancies to these real-world systems to increase system availability and resiliency of these real-world systems.

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A CPP embodiment is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc), or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

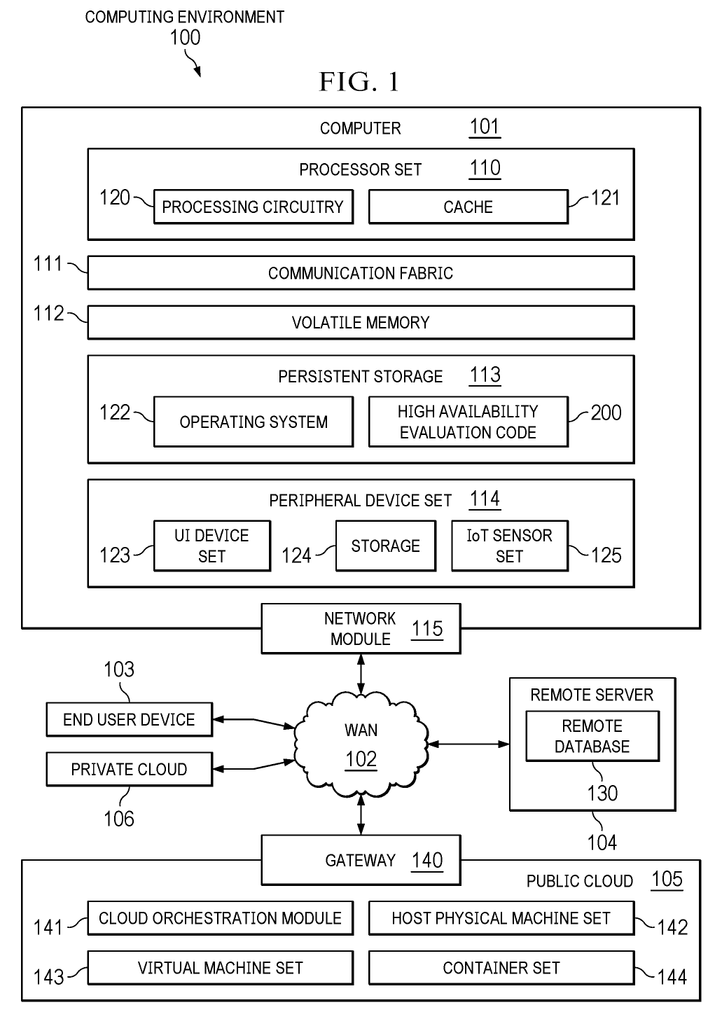

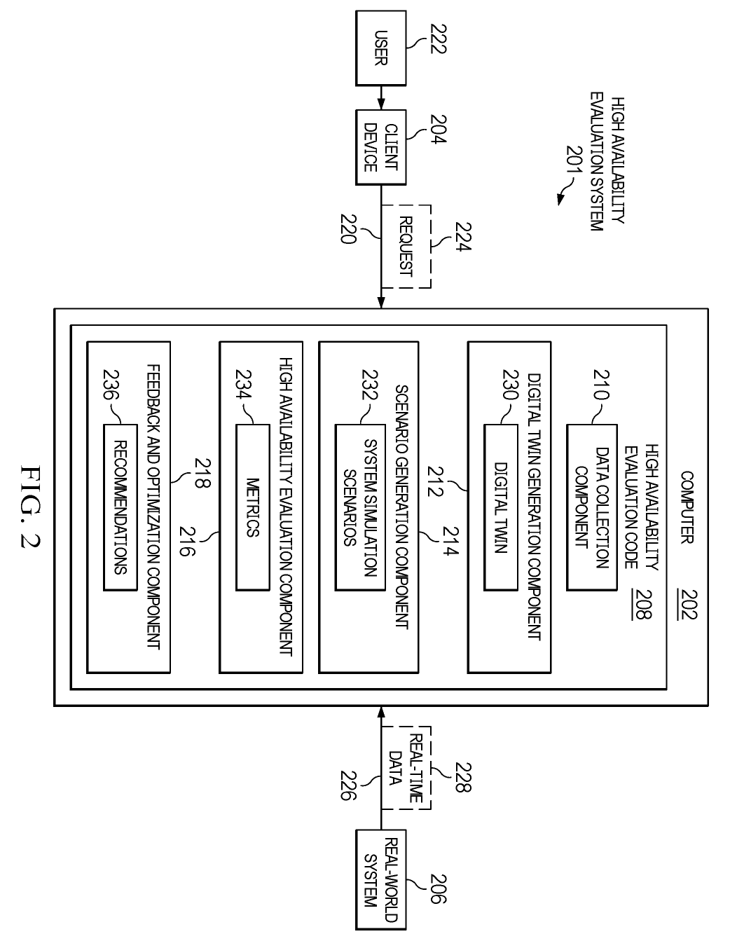

With reference now to the figures, and in particular, with reference to FIG. 1 and FIG. 2, diagrams of data processing environments are provided in which illustrative embodiments may be implemented. It should be appreciated that FIG. 1 and FIG. 2 are only meant as examples and are not intended to assert or imply any limitation with regard to the environments in which different embodiments may be implemented. Many modifications to the depicted environments may be made.

FIG. 1 shows a pictorial representation of a computing environment in which illustrative embodiments may be implemented. Computing environment 100 contains an example of an environment for the execution of at least some of the computer code involved in performing the inventive methods of illustrative embodiments, such as high availability evaluation code 200.

For example, high availability evaluation code 200 is comprised of a data collection component, a digital twin generation component, a scenario generation component, a high availability evaluation component, and a feedback and optimization component. High availability evaluation code 200 utilizes the data collection component to gather real-time data corresponding to a real-world system and sends the real-time data to the digital twin generation component. High availability evaluation code 200 utilizes the digital twin generation component to construct a digital twin (e.g., an exact digital replica or virtual replica) of the real-world system and sends the digital twin to the scenario generation component.

High availability evaluation code 200 utilizes the scenario generation component to create various simulation scenarios for the real-world system based on the digital twin and sends the various simulation scenarios to the high availability evaluation component. High availability evaluation code 200 utilizes the high availability evaluation component to assess the performance of the real-world system under each of the various simulation scenarios and sends the performance assessment results to the feedback and optimization component. High availability evaluation code 200 utilizes the feedback and optimization component to analyze the performance assessment results and provides recommendations that feed back into the real-world system for continuous availability and performance improvement.

In addition to high availability evaluation code 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and high availability evaluation code 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a mainframe computer, quantum computer, desktop computer, laptop computer, tablet computer, or any other form of computer now known or to be developed in the future that is capable of, for example, running a program, accessing a network, and querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods of illustrative embodiments may be stored in high availability evaluation code 200 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports, and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data, and re-writing of data. Some familiar forms of persistent storage include magnetic disks and solid-state storage devices. Operating system 122 may take several forms, such as various known proprietary operating systems or open-source portable operating system interface-type operating systems that employ a kernel.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks, and even connections made through wide area networks such as the internet. In various embodiments, UI device set 123 may include components such as a display screen, speaker, microphone, wearable devices (such as smart glasses and smart watches), keyboard, mouse, printer, touchpad, and haptic devices.

Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (e.g., where computer 101 locally stores and manages a large database) then this storage may be provided by peripheral storage devices designed for storing very large amounts of data, such as a storage area network (SAN) that is shared by multiple, geographically distributed computers.

IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (e.g., embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (e.g., the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and edge servers.

EUD 103 is any computer system that is used and controlled by an end user (e.g., a system administrator or the like who uses the high availability evaluation services provided by computer 101) and may take any of the forms discussed above in connection with computer 101. EUD 103 typically receives helpful and useful data from the operations of computer 101. For example, in a hypothetical case where computer 101 is designed to provide a real-world system high availability recommendation to the end user, this recommendation would typically be communicated from network module 115 of computer 101 through WAN 102 to EUD 103. In this way, EUD 103 can display, or otherwise present, the real-world system high availability recommendation to the end user. In some embodiments, EUD 103 may be a client device, such as a thin client, heavy client, mainframe computer, desktop computer, laptop computer, tablet computer, smart phone, and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a real-world system high availability recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single entity. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Public cloud 105 and private cloud 106 are programmed and configured to deliver cloud computing services and/or microservices (not separately shown in FIG. 1). Unless otherwise indicated, the word “microservices” shall be interpreted as inclusive of larger “services” regardless of size. Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider’s systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of application programming interfaces (APIs). One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

As used herein, when used with reference to items, “a set of” means one or more of the items. For example, a set of clouds is one or more different types of cloud environments. Similarly, “a number of,” when used with reference to items, means one or more of the items. Moreover, “a group of” or “a plurality of” when used with reference to items, means two or more of the items.

Further, the term “at least one of,” when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

For example, without limitation, “at least one of item A, item B, or item C” may include item A, item A and item B, or item B. This example may also include item A, item B, and item C or item B and item C. Of course, any combinations of these items may be present. In some illustrative examples, “at least one of” may be, for example, without limitation, two of item A, one of item B, and ten of item C, or four of item B and seven of item C, or other suitable combinations.

As real-world systems grow increasingly larger and evermore complex, ensuring high availability of these real-world systems becomes even more challenging. Real-world systems may include, for example, preproduction environments, production environments, postproduction environments, testing environments, and the like.

Traditional methods for testing system reliability struggle to account for large-scale real-world system scenarios having unpredictable conditions that can lead to blind spots in system reliability. Entities, such as, for example, enterprises, businesses, companies, organizations, institutions, agencies, and the like need a solution to evaluate how their real-world systems will behave under various complex scenarios, such as, for example, hardware failures, network disruptions, extreme workloads, and the like to ensure that service level agreements (SLAs) and user expectations are met and to optimize resiliency and availability of these real-world systems.

Existing high availability evaluation solutions include, for example, stress testing, chaos engineering, and high-fidelity simulation tools. However, these existing high availability evaluation solutions have issues. For example, stress testing can evaluate system performance under extreme load, but stress testing lacks real-world complexity and does not account for unexpected faults. Chaos engineering can simulate failures in production systems to assess system resiliency, but chaos engineering can be disruptive and risky if not properly controlled. High-fidelity simulation tools can provide insights into specific system scenarios, but high-fidelity simulation tools are limited by predefined inputs and struggle to scale to larger, more dynamic and complex systems.

Illustrative embodiments utilize a digital twin system that generates a digital twin (e.g., a digital or virtual replica) of a real-world system to evaluate whether the real-world system has high availability. By using real-time data and simulating various complex system scenarios, the data twin system can accurately model behavior of the real-world system under stress, network failures, hardware outages, and other conditions without affecting the actual real-world system, such as a live production system.

Illustrative embodiments utilize a data collection component, a digital twin generation component, a scenario generation component, a high availability evaluation component, and a feedback and optimization component to evaluate and optimize availability of a given real-world system. Illustrative embodiments use the data collection component to collect (e.g., receive and/or retrieve) real-time data from system logs, system performance metrics, network status, and system fault records corresponding to the real-world system under evaluation for high availability. The data collection component sends the collected real-time data corresponding to the real-world system to a digital twin generation component.

The digital twin generation component uses the collected real-time data corresponding to the real-world system to build a digital twin (e.g., digital or virtual replica) of that particular real-world system. After building the digital twin, the digital twin generation component sends the digital twin of that particular real-world system to the scenario generation component for high availability evaluation testing.

Upon receiving the digital twin, the scenario generation component generates a set of system simulation scenarios (e.g., hardware failures, network outages, extreme loads, and the like) corresponding to that particular real-world system based on the digital twin of that particular real-world system. It should be noted that illustrative embodiments can limit the number of system simulation scenarios generated to a predetermined number to limit resource utilization and rank the system simulation scenarios in a prioritized order. After generating the set of system simulation scenarios, the scenario generation component sends the set of system simulation scenarios to the high availability evaluation component.

Illustrative embodiments utilize the high availability evaluation component to assess system performance of that particular real-world system under each system simulation scenario of the set of simulation scenarios generated by the scenario generation component using a set of metrics, such as, for example, mean time to repair, mean time between failure, recovery time objective, recovery point objective, service level agreement compliance, and the like. Mean time to repair, also known as mean time to recovery, measures the average time it takes to repair a system after system failure. In other words, the mean time to repair metric evaluates the availability and resiliency of the system. Mean time between failure measures the resiliency of a system. In other words, the mean time between failure metric represents the average time that a system will operate before it fails. Recovery time objective is the length of time the system takes to recover from an outage (e.g., scheduled, unscheduled, or disaster) and resume normal operations. Recovery point objective is the point in time relative to the system failure to which data preservation is needed. Service level agreement compliance is the extent to which the real-world system meets agreed-upon service availability and performance metrics.

In response to assessing the system performance of that particular real-world system under each system simulation scenario using the set of metrics, the high availability evaluation component sends a result of the system performance assessment of that particular real-world system under each system simulation scenario to the feedback and optimization component. Illustrative embodiments utilize the feedback and optimization component to analyze the result of the system performance assessment of that particular real-world system and generate a set of recommendations for increasing system availability and system resiliency of that particular real-world system by, for example, adjusting resource allocations, adding resource redundancies, and the like based on analyzing the result of the system performance assessment.

Illustrative embodiments can send the set of recommendations for increasing the system availability and resiliency of that particular real-world system to a user (e.g., a system administrator or the like) for approval. In response to receiving the approval, illustrative embodiments can automatically implement the set of recommendations in that particular real-world system to increase the availability of that particular real-world system.

Alternatively, illustrative embodiments can use the digital twin generation component to implement the set of recommendations in the digital twin of that particular real-world system to determine whether the set of recommendations actually increase the availability and resiliency of that particular real-world system. In response to determining that the set of recommendations does increase the availability and resiliency of that particular real-world system based on running the set of recommendations in the digital twin, illustrative embodiments automatically implement the set of recommendations in that particular real-world system. Illustrative embodiments utilize the feedback loop of the feedback and optimization component for ongoing refinement of both the real-world system and its digital twin. In response to determining that the set of recommendations does not increase the availability of that particular real-world system based on running the set of recommendations in the digital twin, illustrative embodiments send the set of recommendations to the user for review and correction.

Hence, unlike chaos engineering in production environments, illustrative embodiments allow for safe simulations without impacting live real-world systems and, therefore, reduce the risk to these live real-world systems. In addition, by using real-time data corresponding to real-world systems, illustrative embodiments can generate accurate and relevant digital twins for evaluation of realistic, data-driven simulations. Further, illustrative embodiments can provide scalable testing that can simulate scenarios at various scales, from a small cluster to multiple large data centers. Furthermore, illustrative embodiments provide proactive insights by identifying potential weak points and optimization opportunities before real system failures occur. Moreover, by integrating real-time data, the real-world system can evolve with the changing environment, offering ongoing high availability evaluation for continuous system improvement.

Thus, illustrative embodiments provide one or more technical solutions that overcome a technical problem with an inability of existing solutions to evaluate availability of real-world systems under various complex scenarios with unpredictable conditions. As a result, these one or more technical solutions provide a technical effect and practical application in the field of high availability real-world systems.

With reference now to FIG. 2, a diagram illustrating an example of a high availability evaluation system is depicted in accordance with an illustrative embodiment. High availability evaluation system 201 may be implemented in a computing environment, such as computing environment 100 in FIG. 1. High availability evaluation system 201 includes various hardware and software components for evaluating high availability of real-world systems using digital twins.

In this example, high availability evaluation system 201 includes computer 202, client device 204, and real-world system 206. Computer 202 may be, for example, computer 101 in FIG. 1. Client device 204 may be, for example, EUD 103 in FIG. 1. Real-world system 206 may be, for example, host physical machine set 142 of public cloud 105 in FIG. 1. However, it should be noted that high availability evaluation system 201 is intended as an example only and not as a limitation on illustrative embodiments. For example, high availability evaluation system 201 may include any number of computers, client devices, real-world systems, and other devices and components not shown.

Computer 202 includes high availability evaluation code 208, such as high availability evaluation code 200 in FIG. 1. In this example, high availability evaluation code 208 is comprised of data collection component 210, digital twin generation component 212, scenario generation component 214, high availability evaluation component 216, and feedback and optimization component 218. However, it should be noted that high availability evaluation code 208 may include fewer or more components than shown. For example, two or more components of high availability evaluation code 208 may be combined into one component, one or more components may be divided into two or more components, one or more components may be removed, or one or more components not shown may be added.

In this example, at 220, user 222 sends request 224 to computer 202 via client device 204. User 222 may be, for example, a system administrator. Request 224 is a request for computer 202 to perform a high availability evaluation on real-world system 206.

At 226, in response to receiving request 224, computer 202 utilizes data collection component 210 to gather real-time data 228 corresponding to real-world system 206. Real-time data 228 may include, for example, system logs, performance metrics, network status, fault records, and the like corresponding to real-world system 206.

Data collection component 210 inputs real-time data 228 corresponding to real-world system 206 into digital twin generation component 212. Digital twin generation component 212 generates digital twin 230 of real-world system 206 based on real-time data 228 corresponding to real-world system 206. Digital twin 230 is a digital or virtual representation that accurately reflects the design of real-world system 206.

Digital twin generation component 212 sends digital twin 230 of real-world system 206 to scenario generation component 214. Scenario generation component 214 generates a plurality of simulation scenarios for real-world system 206 based on digital twin 230 of real-world system 206. The plurality of simulation scenarios includes, for example, different hardware failures, different network outages, different greater than normal workload levels, and the like.

Scenario generation component 214 transfers the plurality of simulation scenarios for real-world system 206 to high availability evaluation component 216 for assessment. High availability evaluation component 216, using metrics 234, performs a system availability and system resiliency assessment of real-world system 206 under each respective simulation scenario of the plurality of simulation scenarios generated by scenario generation component 214. Metrics 234 represent a set of metrics that include, for example, mean time to repair metrics, mean time between failure metrics, service level agreement metrics, and the like. High availability evaluation component 216 then generates a result of the system availability and system resiliency assessment of real-world system 206 under each respective simulation scenario of the plurality of simulation scenarios based on metrics 234.

High availability evaluation component 216 inputs the result of the system availability and system resiliency assessment of real-world system 206 into feedback and optimization component 218 for analysis. Based on the analysis of the result of the system availability and system resiliency assessment of real-world system 206, feedback and optimization component 218 generates recommendations 236 for increasing the system availability and system resiliency of real-world system 206. Recommendations 236 represent a set of recommendations that include, for example, adjusting resource allocations of real-world system 206, adding resource redundancies to real-world system 206, and the like for increasing the system availability and system resiliency of real-world system 206.

Feedback and optimization component 218 may send recommendations 236 for increasing the system availability and system resiliency of real-world system 206 to client device 204 for user 222 to review and manually implement recommendations 236 in real-world system 206. Alternatively, computer 202 may automatically implement recommendations 236 in real-world system 206 after receiving approval from user 222 to do so.

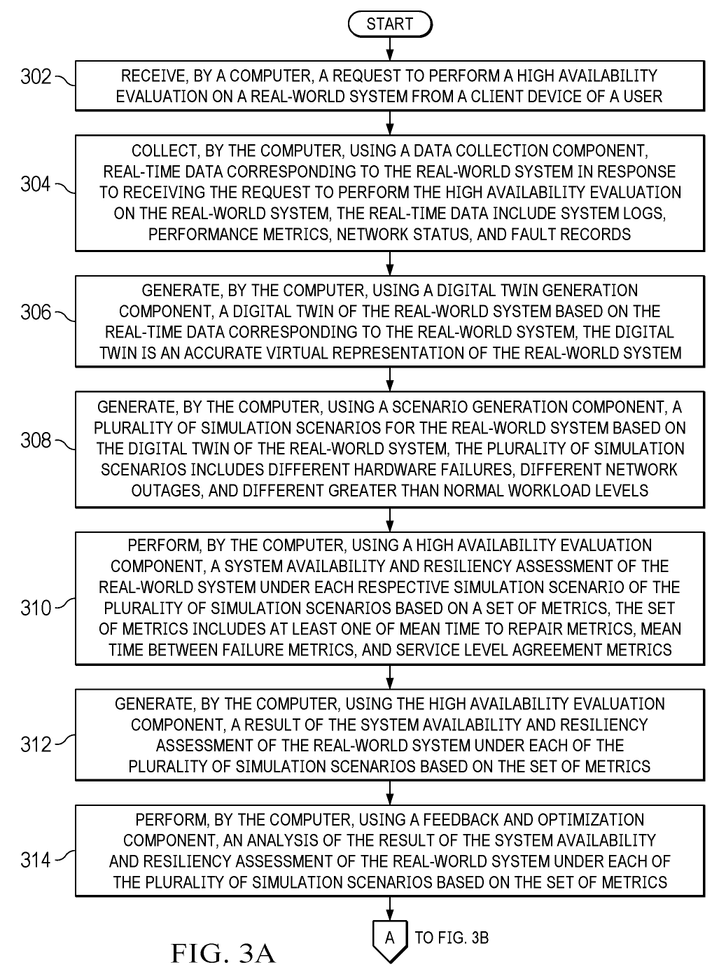

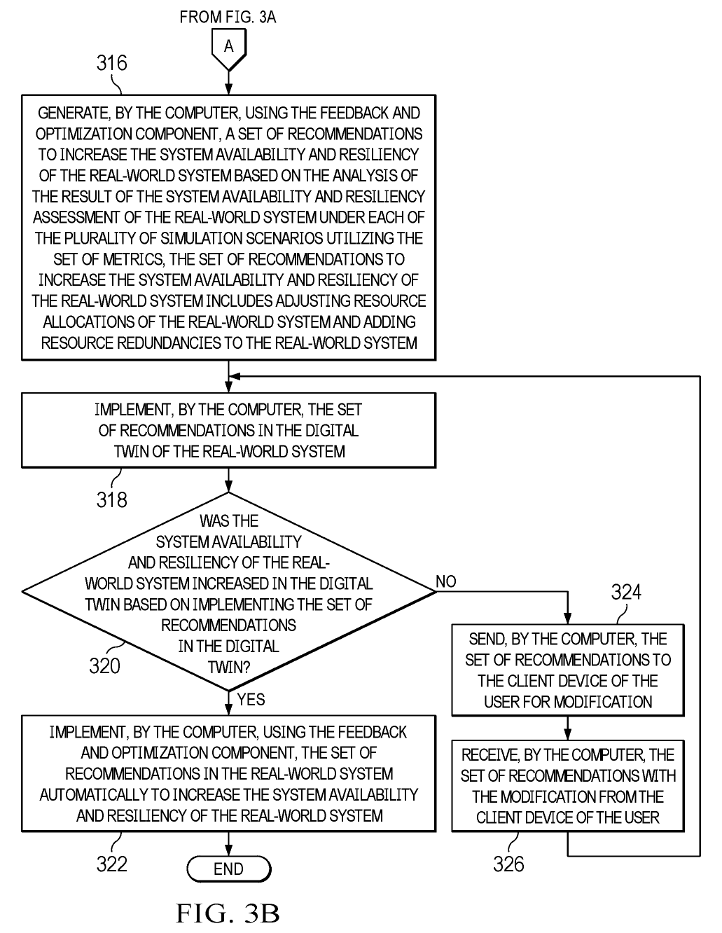

With reference now to FIGS. 3A-3B, a flowchart illustrating a process for evaluating high availability of real-world systems using digital twins is shown in accordance with an illustrative embodiment. The process shown in FIGS. 3A-3B may be implemented in a computer, such as, for example, computer 101 in FIG. 1 or computer 202 in FIG. 2. For example, the process shown in FIGS. 3A-3B may be implemented by high availability evaluation code 200 in FIG. 1 or high availability evaluation code 208 in FIG. 2.

The process begins when the computer receives a request to perform a high availability evaluation on a real-world system from a client device of a user (step 302). In response to receiving the request to perform the high availability evaluation on the real-world system, the computer, using a data collection component, collects real-time data corresponding to the real-world system (step 304). The real-time data include system logs, performance metrics, network status, and fault records.

The computer, using a digital twin generation component, generates a digital twin of the real-world system based on the real-time data corresponding to the real-world system (step 306). The digital twin is an accurate virtual representation of the real-world system. In addition, the computer, using a scenario generation component, generates a plurality of simulation scenarios for the real-world system based on the digital twin of the real-world system (step 308). The plurality of simulation scenarios includes different hardware failures, different network outages, and different greater than normal workload levels.

The computer, using a high availability evaluation component, performs a system availability and resiliency assessment of the real-world system under each respective simulation scenario of the plurality of simulation scenarios based on a set of metrics (step 310). The set of metrics includes at least one of mean time to repair metrics, mean time between failure metrics, and service level agreement metrics. The computer, using the high availability evaluation component, generates a result of the system availability and resiliency assessment of the real-world system under each of the plurality of simulation scenarios based on the set of metrics (step 312).

The computer, using a feedback and optimization component, performs an analysis of the result of the system availability and resiliency assessment of the real-world system under each of the plurality of simulation scenarios based on the set of metrics (step 314). The computer, using the feedback and optimization component, generates a set of recommendations to increase the system availability and resiliency of the real-world system based on the analysis of the result of the system availability and resiliency assessment of the real-world system under each of the plurality of simulation scenarios utilizing the set of metrics (step 316). The set of recommendations to increase the system availability and resiliency of the real-world system includes adjusting resource allocations of the real-world system and adding resource redundancies to the real-world system.

The computer implements the set of recommendations in the digital twin of the real-world system (step 318). The computer makes a determination as to whether the system availability and resiliency of the real-world system was increased in the digital twin based on implementing the set of recommendations in the digital twin (step 320).

If the computer determines that the system availability and resiliency of the real-world system was increased in the digital twin based on implementing the set of recommendations in the digital twin, yes output of step 320, then the computer, using the feedback and optimization component, automatically implements the set of recommendations in the real-world system to increase the system availability and resiliency of the real-world system (step 322). Thereafter, the process terminates.

If the computer determines that the system availability and resiliency of the real-world system was not increased in the digital twin based on implementing the set of recommendations in the digital twin, no output of step 320, then the computer sends the set of recommendations to the client device of the user for modification (step 324). Subsequently, the computer receives the set of recommendations with the modification from the client device of the user for implementation in the digital twin of the real-world system (step 326). Thereafter, the process returns to step 318 where the computer implements the set of recommendations with the modification in the digital twin of the real-world system.

Thus, illustrative embodiments of the present disclosure provide a computer-implemented method, computer system, and computer program product for evaluating high availability of real-world systems using digital twins. The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
performing, by a computer, an analysis of a result of a system availability and resiliency assessment of a real-world system under each of a plurality of simulation scenarios based on a set of metrics; and
generating, by the computer, a set of recommendations to increase system availability and resiliency of the real-world system based on the analysis of the result of the system availability and resiliency assessment of the real-world system under each of the plurality of simulation scenarios utilizing the set of metrics.

2. The method of claim 1, further comprising:
implementing, by the computer, the set of recommendations in a digital twin of the real-world system;
determining, by the computer, whether the system availability and resiliency of the real-world system was increased in the digital twin based on implementing the set of recommendations in the digital twin; and
responsive to the computer determining that the system availability and resiliency of the real-world system was increased in the digital twin based on implementing the set of recommendations in the digital twin, implementing, by the computer, the set of recommendations in the real-world system automatically to increase the system availability and resiliency of the real-world system.

3. The method of claim 2, further comprising:
responsive to the computer determining that the system availability and resiliency of the real-world system was not increased in the digital twin based on implementing the set of recommendations in the digital twin, sending, by the computer, the set of recommendations to a client device of a user for modification; and
receiving, by the computer, the set of recommendations with the modification from the client device of the user for implementation in the digital twin.

4. The method of claim 1, further comprising:
receiving, by the computer, a request to perform a high availability evaluation on the real-world system from a client device of a user; and
collecting, by the computer, real-time data corresponding to the real-world system in response to receiving the request to perform the high availability evaluation on the real-world system, the real-time data include system logs, performance metrics, network status, and fault records.

5. The method of claim 4, further comprising:
generating, by the computer, a digital twin of the real-world system based on the real-time data corresponding to the real-world system, the digital twin is an accurate virtual representation of the real-world system; and
generating, by the computer, the plurality of simulation scenarios for the real-world system based on the digital twin of the real-world system, the plurality of simulation scenarios includes different hardware failures, different network outages, and different greater than normal workload levels.

6. The method of claim 1, further comprising:
performing, by the computer, the system availability and resiliency assessment of the real-world system under each respective simulation scenario of the plurality of simulation scenarios based on the set of metrics, the set of metrics includes at least one of mean time to repair metrics, mean time between failure metrics, and service level agreement metrics; and
generating, by the computer, the result of the system availability and resiliency assessment of the real-world system under each of the plurality of simulation scenarios based on the set of metrics.

7. The method of claim 1, wherein the set of recommendations to increase the system availability and resiliency of the real-world system includes adjusting resource allocations of the real-world system and adding resource redundancies to the real-world system.

8. A computer system comprising:
a processor set;
one or more computer-readable storage media; and
program instructions stored on the one or more computer-readable storage media to cause the processor set to perform operations comprising:
performing an analysis of a result of a system availability and resiliency assessment of a real-world system under each of a plurality of simulation scenarios based on a set of metrics; and
generating a set of recommendations to increase system availability and resiliency of the real-world system based on the analysis of the result of the system availability and resiliency assessment of the real-world system under each of the plurality of simulation scenarios utilizing the set of metrics.

9. The computer system of claim 8, wherein the operations further comprise:
implementing the set of recommendations in a digital twin of the real-world system;
determining whether the system availability and resiliency of the real-world system was increased in the digital twin based on implementing the set of recommendations in the digital twin; and
responsive to determining that the system availability and resiliency of the real-world system was increased in the digital twin based on implementing the set of recommendations in the digital twin, implementing the set of recommendations in the real-world system automatically to increase the system availability and resiliency of the real-world system.

10. The computer system of claim 9, wherein the operations further comprise:
responsive to determining that the system availability and resiliency of the real-world system was not increased in the digital twin based on implementing the set of recommendations in the digital twin, sending the set of recommendations to a client device of a user for modification; and
receiving the set of recommendations with the modification from the client device of the user for implementation in the digital twin.

11. The computer system of claim 8, wherein the operations further comprise:
receiving a request to perform a high availability evaluation on the real-world system from a client device of a user; and
collecting real-time data corresponding to the real-world system in response to receiving the request to perform the high availability evaluation on the real-world system, the real-time data include system logs, performance metrics, network status, and fault records.

12. The computer system of claim 11, wherein the operations further comprise:
generating a digital twin of the real-world system based on the real-time data corresponding to the real-world system, the digital twin is an accurate virtual representation of the real-world system; and
generating the plurality of simulation scenarios for the real-world system based on the digital twin of the real-world system, the plurality of simulation scenarios includes different hardware failures, different network outages, and different greater than normal workload levels.

13. The computer system of claim 8, wherein the operations further comprise:
performing the system availability and resiliency assessment of the real-world system under each respective simulation scenario of the plurality of simulation scenarios based on the set of metrics, the set of metrics includes at least one of mean time to repair metrics, mean time between failure metrics, and service level agreement metrics; and
generating the result of the system availability and resiliency assessment of the real-world system under each of the plurality of simulation scenarios based on the set of metrics.

14. A computer program product comprising:
one or more computer-readable storage media; and
program instructions stored on the one or more computer-readable storage media to perform operations comprising:
performing, by a computer, an analysis of a result of a system availability and resiliency assessment of a real-world system under each of a plurality of simulation scenarios based on a set of metrics; and
generating, by the computer, a set of recommendations to increase system availability and resiliency of the real-world system based on the analysis of the result of the system availability and resiliency assessment of the real-world system under each of the plurality of simulation scenarios utilizing the set of metrics.

15. The computer program product of claim 14, wherein the operations further comprise:
implementing, by the computer, the set of recommendations in a digital twin of the real-world system;
determining, by the computer, whether the system availability and resiliency of the real-world system was increased in the digital twin based on implementing the set of recommendations in the digital twin; and
responsive to the computer determining that the system availability and resiliency of the real-world system was increased in the digital twin based on implementing the set of recommendations in the digital twin, implementing, by the computer, the set of recommendations in the real-world system automatically to increase the system availability and resiliency of the real-world system.

16. The computer program product of claim 15, wherein the operations further comprise:
responsive to the computer determining that the system availability and resiliency of the real-world system was not increased in the digital twin based on implementing the set of recommendations in the digital twin, sending, by the computer, the set of recommendations to a client device of a user for modification; and
receiving, by the computer, the set of recommendations with the modification from the client device of the user for implementation in the digital twin.

17. The computer program product of claim 14, wherein the operations further comprise:
receiving, by the computer, a request to perform a high availability evaluation on the real-world system from a client device of a user; and
collecting, by the computer, real-time data corresponding to the real-world system in response to receiving the request to perform the high availability evaluation on the real-world system, the real-time data include system logs, performance metrics, network status, and fault records.

18. The computer program product of claim 17, wherein the operations further comprise:
generating, by the computer, a digital twin of the real-world system based on the real-time data corresponding to the real-world system, the digital twin is an accurate virtual representation of the real-world system; and
generating, by the computer, the plurality of simulation scenarios for the real-world system based on the digital twin of the real-world system, the plurality of simulation scenarios includes different hardware failures, different network outages, and different greater than normal workload levels.

19. The computer program product of claim 14, wherein the operations further comprise:
performing, by the computer, the system availability and resiliency assessment of the real-world system under each respective simulation scenario of the plurality of simulation scenarios based on the set of metrics, the set of metrics includes at least one of mean time to repair metrics, mean time between failure metrics, and service level agreement metrics; and
generating, by the computer, the result of the system availability and resiliency assessment of the real-world system under each of the plurality of simulation scenarios based on the set of metrics.

20. The computer program product of claim 14, wherein the set of recommendations to increase the system availability and resiliency of the real-world system includes adjusting resource allocations of the real-world system and adding resource redundancies to the real-world system.
